(19) United States
(12) Patent Application Publication
(10) Pub. No.: US 2014/0082901 A1
(43) Pub. Date: Mar. 27, 2014

(54) Safety Hook

(71) Applicant: Neng-Yuan Yeh, Changhua City (TW)

(72) Inventor: Neng-Yuan Yeh, Changhua City (TW)

(21) Appl. No.: 13/939,337

(22) Filed: Jul. 11, 2013

(30) Foreign Application Priority Data
Sep. 25, 2012 (TW) 101218582

(51) Int. Cl. F16B 45/02

(52) U.S. Cl. CPC F16B 45/02
USPC 24/599.1

(57) ABSTRACT

A safety hook contains a body, a bolt member, a torsion spring, a spring coil, an elastic piece, and an actuation member. The body includes a recess and a through hole, the bolt member includes two orifices, an extension, and an aperture, such that a first foot of the torsion spring is limited in the aperture through the extension. The actuation member includes a chamber for receiving the elastic piece, the spring coil, the torsion spring, and the bolt member. The actuation member also includes two notches corresponding to each other, wherein the actuation member further includes a raised fence arranged in the chamber thereof below a notch of the upper end of the outer wall of the actuation member and includes a longitudinal slot formed on the raised fence, such that a second foot of the torsion spring is limited in the longitudinal slot of the actuation member.

### FIELD OF THE INVENTION

The present invention relates to a safety hook in which the longitudinal slot of the actuation member is covered by the raised fence of the chamber so as to obtain sufficient support, hence when the safety hook receives a downward pulling force, it cannot break.

### BACKGROUND OF THE INVENTION

Referring to FIG. 1, a conventional hook contains a body A, a bolt member B, a torsion spring C, an actuation member D, a spring coil E, and an elastic piece F. The body A is formed in a C shape and includes a recess A1 defined on an upper end thereof and a through hole A2 formed on a lower end thereof. The bolt member B includes two orifices B1 passing through an upper end and a lower end thereof, an extension B2 defined between the upper end and the lower end of the bolt member B, a raised ring B3 surrounding around a middle section of the extension B2, and an aperture B4 arranged on the raised ring B3, such that a first foot C1 of the torsion spring C is limited in the aperture B4, and then the bolt member B, the torsion spring C, the spring coil E, and the elastic piece F are received in a chamber D1 of the actuation member D, thereafter two positioning bolts G are fixed into the through hole A2 and the recess A1 (as illustrated in FIG. 2). The actuation member D includes two notches D2 formed on an upper end and a lower end of an outer wall thereof, the actuation member D also includes a longitudinal slot D3 extending from a notch D2 of the upper end of the outer wall thereof so that the first foot C1 of the torsion spring C is limited in the notch D2 of the upper end of the outer wall of the actuation member D (as shown in FIG. 2). However, when the conventional hook is pulled downwardly, the longitudinal slot D3 is broken easily (as illustrated in FIG. 3).

The present invention has arisen to mitigate and/or obviate the afore-described disadvantages.

### SUMMARY OF THE INVENTION

The primary object of the present invention is to provide a safety hook in which the longitudinal slot of the actuation member is covered by the raised fence of the chamber so as to obtain sufficient support, hence when the safety hook receives a downward pulling force, it cannot break.

Another object of the present invention is to provide a safety hook which is assembled quickly.

To obtain the above objectives, a safety hook contains: a body, a bolt member, a torsion spring, a spring coil, an elastic piece, and an actuation member.

The body is formed in a C shape and includes a recess defined on an upper end thereof and a through hole formed on a lower end thereof. The bolt member includes two orifices passing through an upper end and a lower end thereof, an extension defined between the upper end and the lower end of the bolt member, and an aperture arranged on the extension of the bolt member proximate to a through hole which passes through the upper end of the bolt member, such that a first foot of the torsion spring is limited in the aperture through the extension of the bolt member. The actuation member includes a chamber formed therein so as to receive the elastic piece, the spring coil, the torsion spring, and the bolt member. The actuation member also includes two notches formed on an upper end and a lower end of an outer wall thereof, and the two notches corresponding to each other, characterized in that: the actuation member further includes a raised fence arranged in the chamber thereof below a notch of the upper end of the outer wall of the actuation member and includes a longitudinal slot formed on the raised fence, such that a second foot of the torsion spring is limited in the longitudinal slot of the actuation member.

### BRIEF DESCRIPTION OF THE DRAWINGS

FIG. 1 is a perspective view showing the exploded components of a conventional hook.

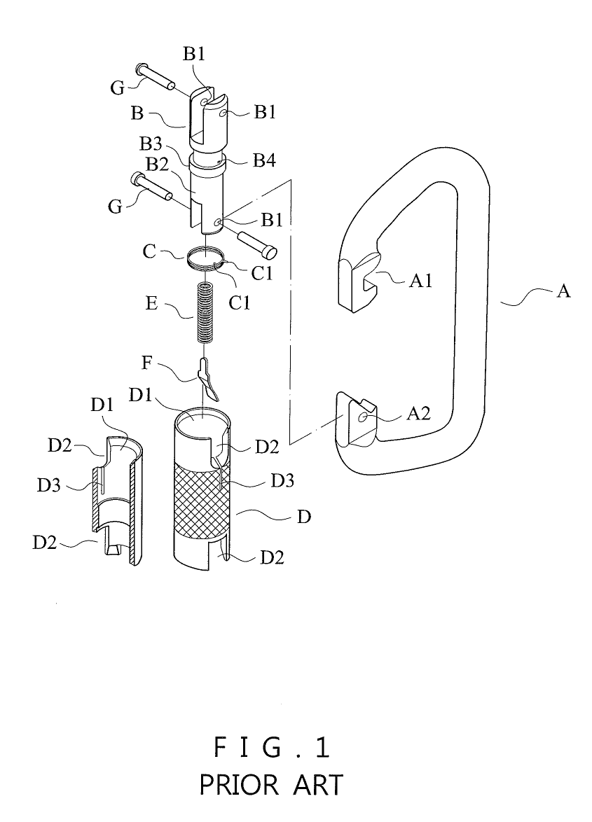

FIG. 2 is a cross sectional view showing the assembly of the conventional hook.

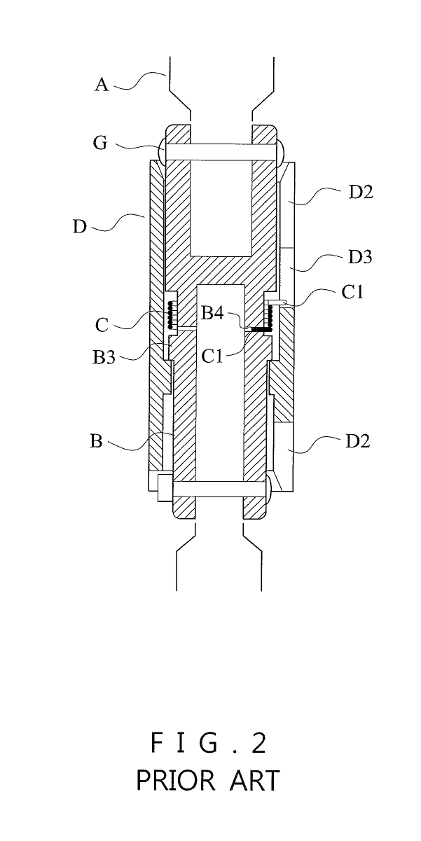

FIG. 3 is a perspective view showing the assembly of the conventional hook.

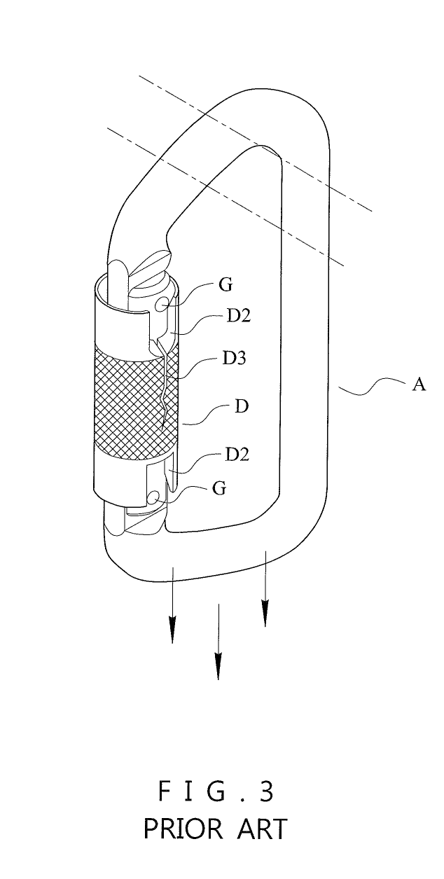

FIG. 4 is a perspective view showing the exploded components of a safety hook according to a preferred embodiment of the present invention.

FIG. 5 is a cross sectional view showing the assembly of the safety hook according to the preferred embodiment of the present invention.

FIG. 6 is a perspective view showing the assembly of the safety hook according to the preferred embodiment of the present invention.

FIG. 7 is a perspective view showing the exploded components of a safety hook according to another preferred embodiment of the present invention.

FIG. 8 is a cross sectional view showing the assembly of the safety hook according to another preferred embodiment of the present invention.

FIG. 9 is a perspective view showing the assembly of the safety hook according to another preferred embodiment of the present invention.

### DETAILED DESCRIPTION OF THE PREFERRED EMBODIMENTS

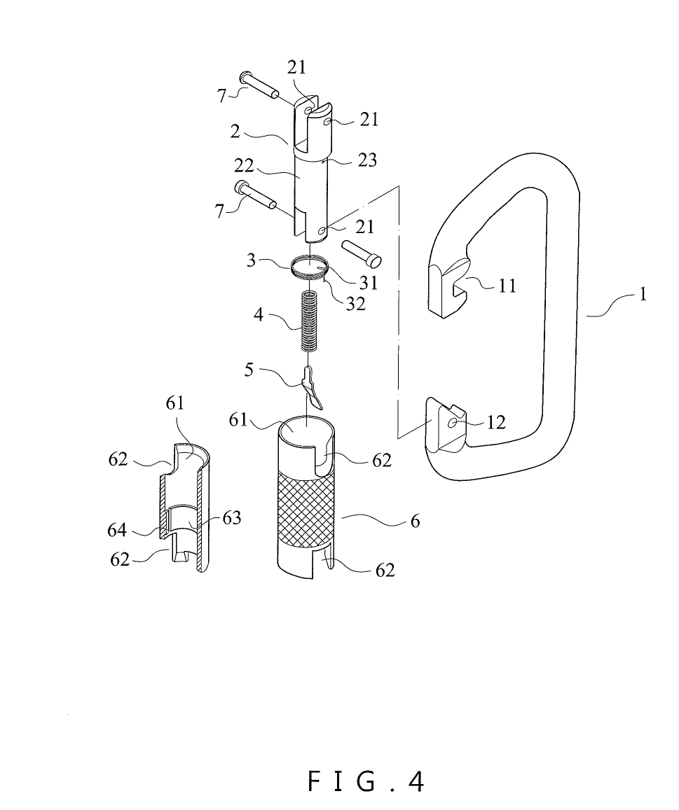

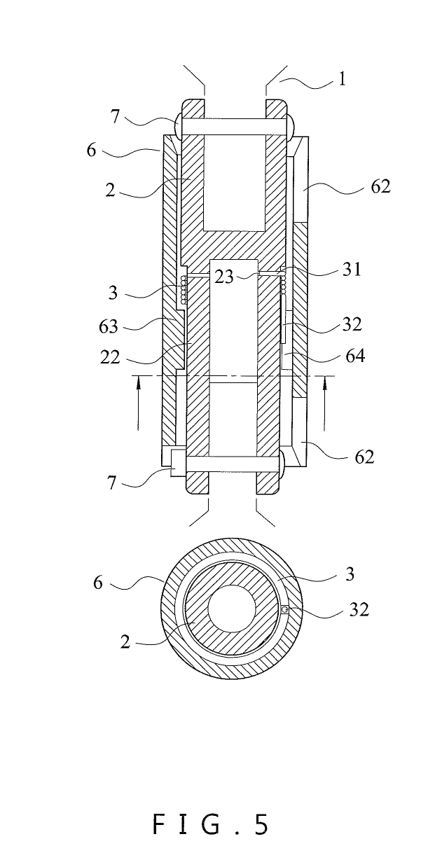

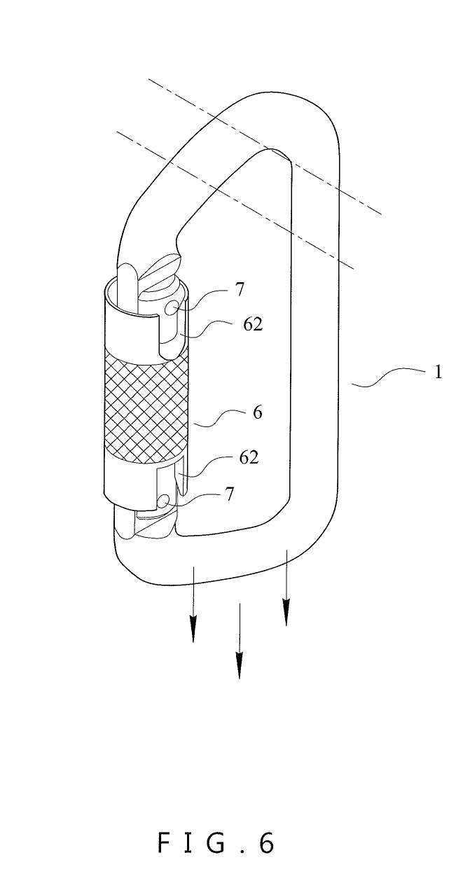

With reference to FIG. 4, a safety hook according to a preferred embodiment of the present invention comprises a body 1, a bolt member 2, a torsion spring 3, a spring coil 4, an elastic piece 5, and an actuation member 6. The body 1 is formed in a C shape and includes a recess 11 defined on an upper end thereof and a through hole 12 formed on a lower end thereof. The bolt member 2 includes two orifices 21 passing through an upper end and a lower end thereof, an extension 22 defined between the upper end and the lower end of the bolt member 2, and an aperture 23 arranged on the extension 22 of the bolt member 2 proximate to a through hole 21 which passes through the upper end of the bolt member 2, such that a first foot 31 of the torsion spring 3 is limited in the aperture 23 through the extension 22 of the bolt member 2. The actuation member 6 includes a chamber 61 formed therein so as to receive the elastic piece 5, the spring coil 4, the torsion spring 3, and the bolt member 2. The actuation member 6 also includes two notches 62 formed on an upper end and a lower end of an outer wall thereof, and the two notches 62 correspond to each other. The actuation member 6 further includes a raised fence 63 arranged in the chamber 61 thereof below a notch 62 of the upper end of the outer wall of the actuation member 6 and includes a longitudinal slot 64 formed on the raised fence 63, such that a second foot 32 of the torsion spring 3 is limited in the longitudinal slot 64 of the actuation member 6. The safety hook further comprises two positioning bolts 7 fixed in the body 1 as shown in FIGS. 5 and 6.

Thereby, the longitudinal slot 64 of the actuation member 6 is covered by the raised fence 63 of the chamber 61 so as to obtain sufficient support, hence when the safety hook receives a downward pulling force, it cannot break. In addition, the safety hook is assembled quickly.

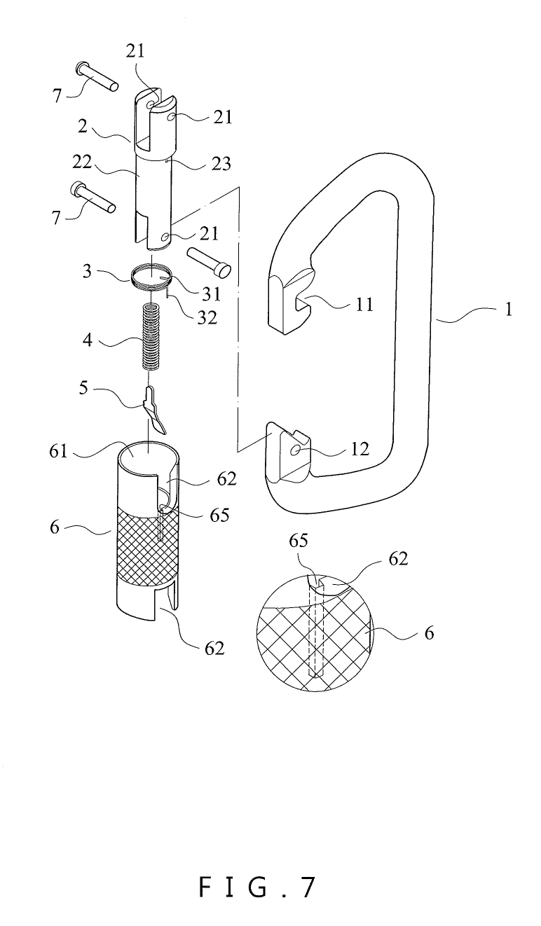

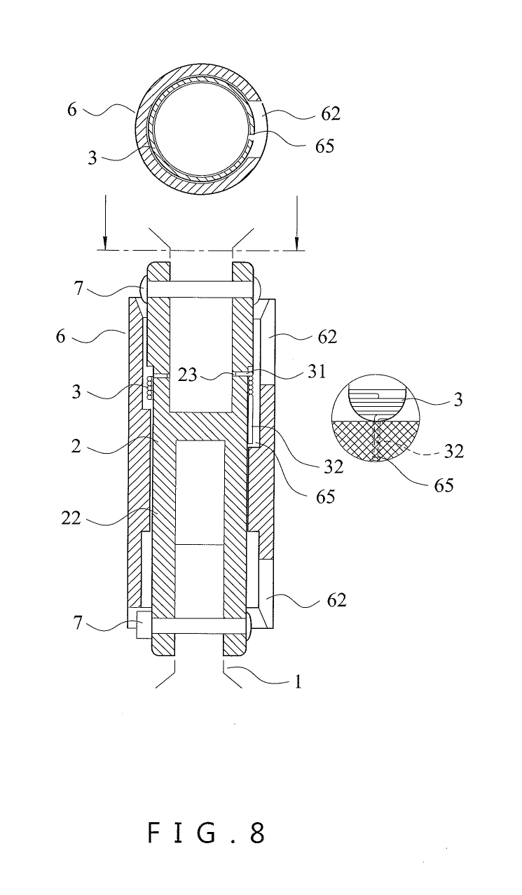

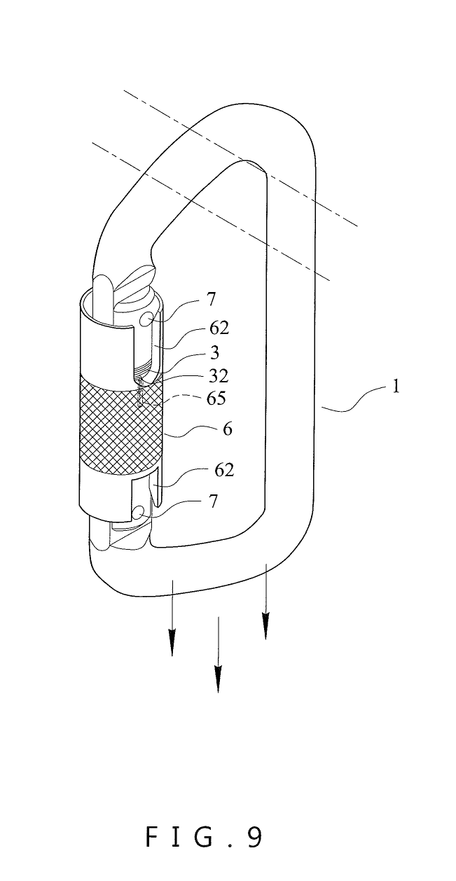

In another embodiment, the notch 62 of the upper end of the actuation member 6 has a trench 65 defined on an inner wall thereof (as illustrated in FIG. 7) so that the second foot 32 of the torsion spring 3 is limited in the trench 65 (as shown in FIGS. 8 and 9) such that when the safety hook receives a downward pulling force, it cannot break. Moreover, the safety hook is assembled quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A safety hook comprising: a body, a bolt member, a torsion spring, a spring coil, an elastic piece, and an actuation member; the body being formed in a C shape and including a recess defined on an upper end thereof and a through hole formed on a lower end thereof; the bolt member including two orifices passing through an upper end and a lower end thereof, an extension defined between the upper end and the lower end of the bolt member, and an aperture arranged on the extension of the bolt member proximate to a through hole which passes through the upper end of the bolt member, such that a first foot of the torsion spring is limited in the aperture through the extension of the bolt member, the actuation member including a chamber formed therein so as to receive the elastic piece, the spring coil, the torsion spring, and the bolt member, the actuation member also including two notches formed on an upper end and a lower end of an outer wall thereof, and the two notches corresponding to each other, characterized in that: the actuation member further includes a raised fence arranged in the chamber thereof below a notch of the upper end of the outer wall of the actuation member and includes a longitudinal slot formed on the raised fence, such that a second foot of the torsion spring is limited in the longitudinal slot of the actuation member.

2. The safety hook as claimed in claim 1, wherein the notch of the upper end of the actuation member has a trench defined on an inner wall thereof so that the second foot of the torsion spring is limited in the trench.
